(19) United States
(12) Patent Application Publication
(10) Pub. No.: US 2008/0030906 A1
(43) Pub. Date: Feb. 7, 2008

(54) MAGNETORESISTIVE EFFECT ELEMENT AND MAGNETIC MEMORY DEVICE

(75) Inventor: Yoshihiro SATO, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/848,697

(22) Filed: Aug. 31, 2007

Related U.S. Application Data
(63) Continuation of application No. PCT/JP2005/003400, filed on Mar. 1, 2005.

(51) Int. Cl. G11B 5/33

(52) U.S. Cl. 360/324.2

(57) ABSTRACT

A magnetoresistive effect element comprises a first magnetic layer having a pinned magnetization direction, and a second magnetic layer having a magnetization direction changed corresponding to an outside magnetic field. A resistance state is changed corresponding to the magnetization direction of the second magnetic layer corresponding to the magnetization direction of the first magnetic layer. The second magnetic layer has a first recess which is dented toward an inside in one side parallel with a hard magnetization axis direction and a second recess dented toward the inside in the other side parallel with the hard magnetization axis direction.

### CROSS REFERENCE TO RELATED APPLICATIONS

This application is a Continuation of International Application No. PCT/JP2005/003400, with an international filing date of Mar. 1, 2005, which designating the United States of America, the entire contents of which are incorporated herein by reference.

### TECHNICAL FIELD

The present invention relates to a magnetoresistive effect element and a magnetic memory device, more specifically a magnetoresistive effect element whose resistance value is changed based on magnetization directions of the magnetic layers, and a magnetic memory device using the magnetoresistive effect element.

### BACKGROUND

Recently, as a rewritable nonvolatile memory, the magnetic random access memory (hereinafter called MRAM) including magnetoresistive effect elements arranged in a matrix is noted. The MRAM memorizes information by using combinations of magnetization directions of the magnetic layers and reads memorized information by detecting resistance changes (i.e., current changes or voltage changes) between the parallel magnetization directions of the magnetic layers and the anti-parallel magnetization directions of the magnetic layers.

As one of the magnetoresistive effect elements forming the MRAM is known the magnetic tunnel junction (Hereinafter called MTJ) element. The MTJ element includes two ferromagnetic layers stacked with a tunnel insulating film formed therebetween and utilizes the phenomenon that the tunneling current flowing between the magnetic layers via the tunnel insulating film changes based on relationships of the magnetization directions of the two ferromagnetic layers. That is, the MTJ element has low element resistance when the magnetization directions of the two ferromagnetic layers is parallel with each other, and when the magnetization directions of the two ferromagnetic layers are anti-parallel with each other, has high element resistance. These two states are related to data “0” and date “1” to be used as the memory device.

As a method for rewriting the memory states of the MTJ element is generally flowing current through two signal lines (e.g., a bit line and a write word line) orthogonally intersecting each other and applying a synthesized magnetic field of magnetic fields generated from these signal lines.

One of the problems of the MRAM is to decrease the electric power consumption for the writing. One means for realizing this is to decease the current in the writing operation. Another problem of the MRAM is to rewrite such a large number of the MTJ elements as above megabit MTJ elements, and the rewriting operation requires large margins.

One of the methods for ensuring a large margin of the rewriting operation is known the rewriting operation by the rotation of a synthesized magnetic field to be applied to the MTJ element, the so-called toggle operation (refer to, e.g., M. Durlam et al., “A 0.18 μm 4 Mb toggling MRAM”, IEDM 2003). However, the toggle operation increases the rewriting operation margin but has disadvantages that 1) the electric power consumption is large, and that 2) the reading operation for confirming memory states is necessary before a rewriting operation, which makes the rewriting operation time long.

Another method for ensuring a writing operation margin is known optimizing the shape of the MTJ element. The characteristic curve representing the relationships of applied magnetic fields and the magnetization switching magnetic fields, the so-called asteroid curve is known. The asteroid curve depends on a shape, a size, a layer structure, etc. of the MTJ element, and the recess of the asteroid curve is increased to thereby enlarge the rewriting operation margin. FIGS. 1A to 1C are views showing plan shapes of the MTJ element 100 proposed in view of this (refer to, e.g., Japanese published unexamined patent application No. 2003-151260 and Y. K. Ha et al., “MRAM with novel shaped cell using synthetic anti-ferromagnetic free layer”, 2004 Symposium on VLSI Technology, Digest of Technical Papers, pp. 24-25). The other related arts are disclosed in, e.g., Japanese published unexamined patent application No. 2004-128067.

However, as the memory capacity of the magnetic memory device is increased, larger writing operation margins and the decrease of the rewriting current are required. The conventional magnetic memory device, which improves these problems by contriving plane shapes of the MTJ element has the shapes complicated in terms of the patterning rule of the present silicon technology. To form the MTJ element of such pattern and to further downsizing especially the MTJ element, new processing techniques are necessary.

Thus, it is difficult for the conventional magnetoresistive effect elements and the magnetic memory devices to lower the rewriting current, to widen the writing operation margins and to easily process by using general silicon process.

A magnetoresistive effect element in accordance with various embodiments of the present invention includes a first magnetic layer having a pinned magnetization direction, and a second magnetic layer having a magnetization direction changed corresponding to an outside magnetic field, a resistance state being changed corresponding to the magnetization direction of the second magnetic layer corresponding to the magnetization direction of the first magnetic layer, the second magnetic layer having a first recess which is dented toward an inside in one side parallel with a hard magnetization axis direction and a second recess dented toward the inside in the other side parallel with the hard magnetization axis direction.

### BRIEF DESCRIPTION OF DRAWINGS

FIGS. 1A-1C are plan views showing the shapes of the magnetoresistive effect elements.

FIG. 2 is a plan view showing a structure of the magnetic memory device according to an embodiment of the present invention.

FIG. 3 is a diagrammatic sectional view showing the structure of the magnetic memory device according to an embodiment of the present invention.

FIG. 4 is an enlarged partial sectional view showing the structure of the magnetic memory device according to an embodiment of the present invention.

FIGS. 5A and 5B are plan views showing a shape of the magnetoresistive effect element according to an embodiment of the present invention.

FIGS. 6A and 6B are plan views showing magnetized states of the magnetoresistive effect element according to an embodiment of the present invention.

FIGS. 7A and 7B are views explaining asteroid curves of the magnetoresistive effect element and writing operation margins estimated based on the asteroid curves.

FIG. 8 is a graph showing asteroid curves of magnetoresistive effect elements given by simulation.

FIG. 9 is a graph showing asteroid curve and the writing operation margin of the conventional magnetoresistive effect element given by simulation.

FIG. 10 is a graph showing asteroid curve and the writing operation margin of the magnetoresistive effect element according to an embodiment of the present invention given by simulation.

FIG. 11 is a graph showing asteroid cures of the C-shaped magnetized state and the S-shaped magnetized state.

FIGS. 12A-12D, 13A-13C, 14A-14C and 15A-15F are cross sectional views showing the method of manufacturing the magnetic memory device according to an embodiment of the present invention.

FIGS. 16A-16C are plan views showing the shapes of the MTJ elements according to the other embodiments of the present invention.

### DETAILED DESCRIPTION OF THE EMBODIMENTS

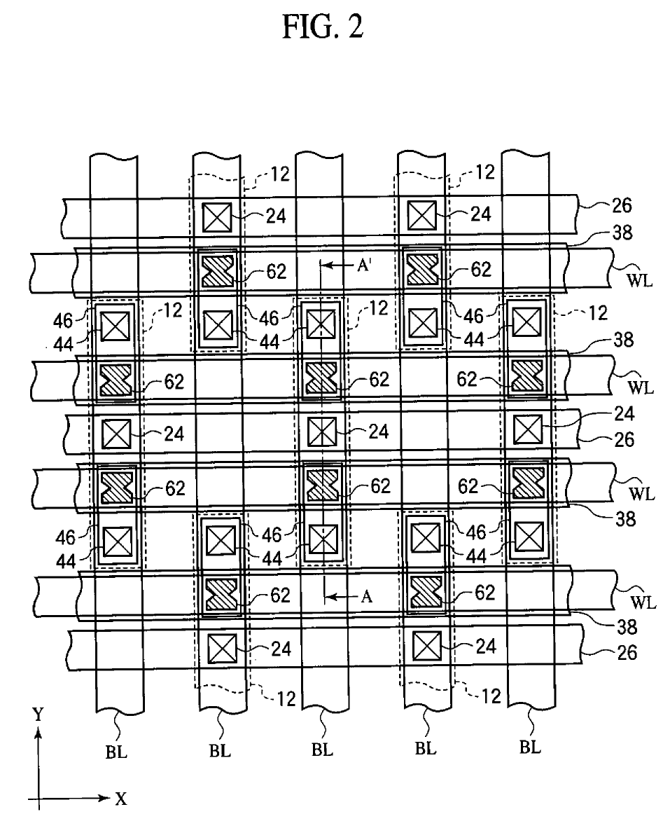

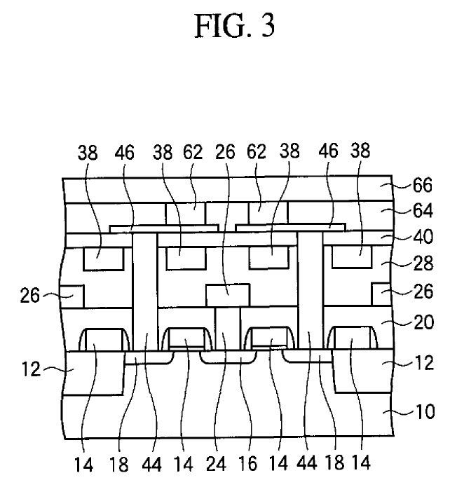

The magnetoresistive effect element and the magnetic memory device according to an embodiment of the present invention will be explained with reference to FIGS. 2 to 15F.

First, the structures of the magnetoresistive effect element and the magnetic memory device according to an embodiment of the present invention will be explained with reference to FIGS. 2 to 11.

In a silicon substrate 10, a device isolation film 12 for defining a plurality of active regions is formed. The plural active regions respectively have a rectangular shape which is elongated in the Y-direction and are arranged zigzag with respect to each other.

Over the silicon substrate 10 with the device isolation film 12 formed in, a plurality of word lines WL are formed, extended in the X-direction. The word lines WL are extended two in each active region. In the active regions on both sides of the respective word lines, source/drain regions 16, 18 are respectively formed. Thus, in each active region, two select transistors each including a gate electrode 14 formed by the word line WL and the source/drain regions 16, 18 are formed. The two select transistors formed in one active region have the source/drain region 16 in common.

Over the silicon substrate 10 with the select transistors formed on, an inter-layer insulating film 20 is formed. In the inter-layer insulating film 20, contact plugs 24 connected to the source/drain regions 16 are buried. On the inter-layer insulating film 20, ground lines 26 electrically connected to the source/drain regions 16 via contact plugs 24 are formed.

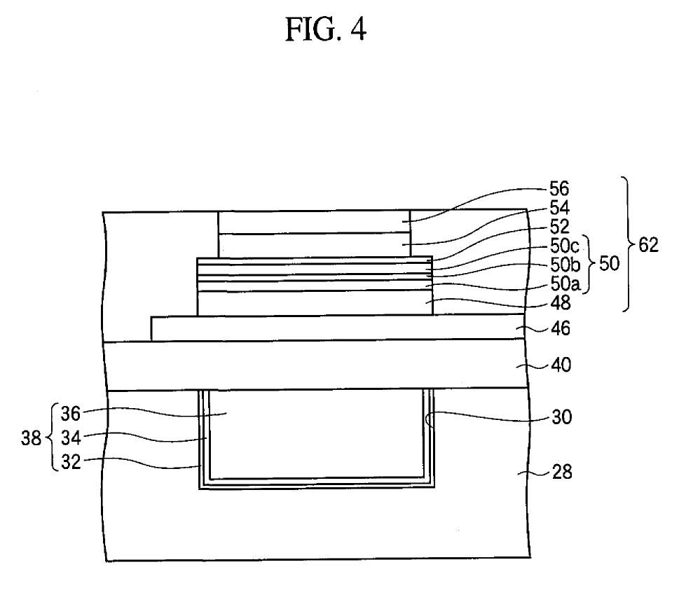

Over the inter-layer insulating film 20 with the ground lines 26 formed on, an inter-layer insulating film 28 is formed. In the inter-layer insulating film 28, write word lines 38 are buried. The write word lines 38 are formed above the gate electrodes 14. As shown in FIG. 4, the write word lines 38 are formed of a Ta film 32 as a barrier metal formed along the inside walls of the interconnection trenches 30, an NiFe film 34 of high magnetic permeability provided for intensifying the magnetic fields and a Cu film 36 which is the major interconnection part.

Over the inter-layer insulating film 28 with the write word lines 38 buried in, an inter-layer insulating film 40 is formed. In the inter-layer insulating films 40, 28, 20, contact plugs 44 connected to the source/drain regions 18 are buried.

Over the inter-layer insulating film 40 with the contact plugs 44 buried in, a lower electrode layer 46 electrically connected to the source/drain regions 18 via the contact plugs 44 is formed. On the lower electrode layer 48, MTJ elements 62 are formed.

As shown in FIG. 4, the MTJ elements 62 includes a pinned magnetization layer of a layer film of an antiferromagnetic layer 48 of PtMn film, a CoFe film 50a, which is a ferromagnetic material, an Ru film 50b, which is a non-magnetic material, and a CoFe film 50c, which is a ferromagnetic material, a tunnel insulating film 52 of alumina film; and a free magnetization layer 54 of NiFe film, which is a ferromagnetic material, and a cap layer 56 of Ta film.

Over the inter-layer insulating film 40 except the parts thereof where the MTJ elements 62 are formed, an inter-layer insulating film 64 is formed. Over the inter-layer insulating film 40 with the MTJ elements 62 buried in, a plurality of bit lines 66 (BL) are formed, electrically connected to the MTJ elements 62 on the cap layer 56. The bit lines 66 are extended in the Y-direction and connected to the cap layer 60 of the MTJ elements 62 arranged in the Y-direction.

Thus, the magnetic memory device including memory cells of 1T-1MTJ type each including one select transistor and one MTJ element.

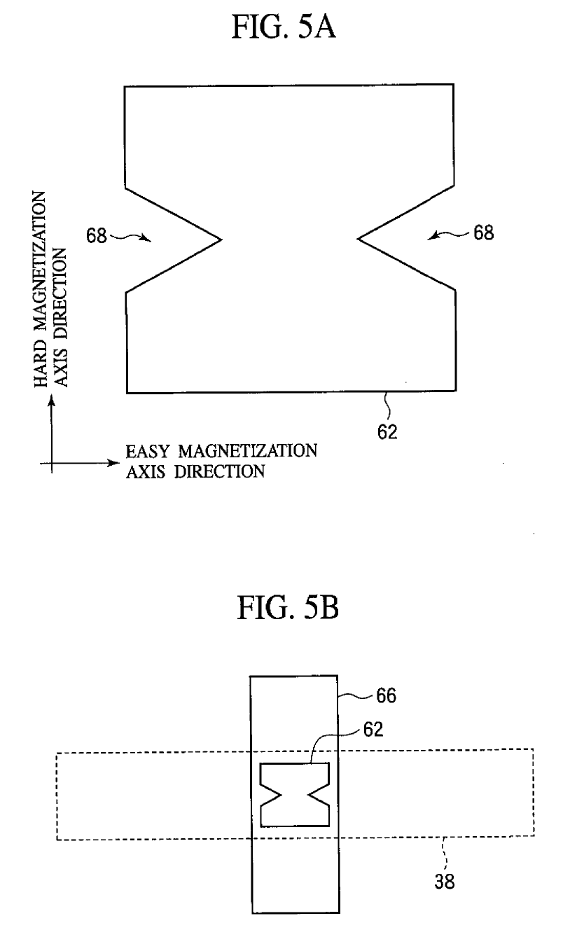

As shown in FIG. 5A, each MTJ element of the magnetic memory device according to the present embodiment has recesses 68 formed in both of a pair of sides which are in parallel with the hard magnetization axis and has a smaller width at the middle than at the ends. As shown in FIGS. 2 and 5B, the MTJ elements 62 are located in the regions where the write word lines 38 and the bit lines 66 intersect each other and are arranged with the easy magnetization axis being in parallel with the extension of the write word lines 38 and the hard magnetization axis being in parallel with the extension of the bit lines 66.

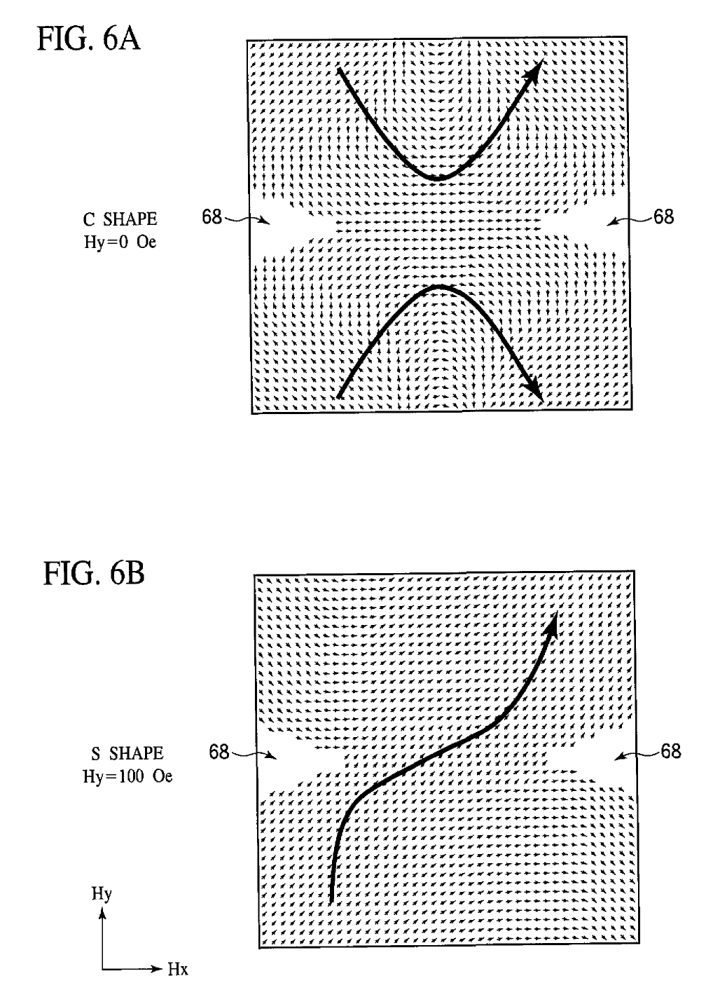

FIGS. 6A and 6B are views showing the result of the magnetization of the magnetoresistive effect element according to the present embodiment given by LLG simulation. FIG. 6A shows the magnetization switching with an applied magnetic field in the easy magnetization axis direction when an applied magnetic field in the hard magnetization axis direction is 0 Oe, and FIG. 6B shows the magnetization switching with an applied magnetic field in the easy magnetization axis direction when an applied magnetic field in the hard magnetization axis direction is 100 Oe. In the drawings, the small arrows indicate magnetization direction in the magnetic domains there, and the large arrows roughly indicate the general directions of the magnetization directions in the respective magnetic domains.

When a magnetic field is applied in the easy magnetization axis direction (Hx direction), and no magnetic field is applied in the hard magnetization axis direction (Hy direction), as shown in FIG. 6A, the magnetization directions of the respective magnetic domains at the middle part where the recesses 68 are formed are oriented in the easy magnetization axis direction. In contrast to this, in the region upper of the recesses 68 and in the region below the recesses 68, the magnetization directions are upward and downward symmetrical to the middle part. In the respective regions, the magnetization directions of the respective magnetic domains are oriented in the hard magnetization axis direction, drawing arcs having summits at the central parts of the MTJ element. That is, the magnetization directions of the respective magnetic domains in plane of the MTJ element are upward and downward symmetric to the middle part where the recesses 68 are formed, and the magnetizations directions of the respective magnetic domains in the respective regions are oriented, generally drawing C-shapes. Hereinafter, such magnetization state of the magnetization directions of the respective magnetic domains will be called C-shape.

When magnetic fields are applied in the easy magnetization axis direction (Hx direction) and in the hard magnetization axis direction (Hy direction), as shown in FIG. 6B, the magnetization directions of the respective magnetic domains are oriented generally in directions of a synthetic magnetic field of a magnetic field applied in the easy magnetization axis direction and a magnetic field applied in the hard magnetization axis direction. However, because of the presence of the recesses 68, the orientations of the magnetization directions of the respective magnetic domains a little curve and are oriented, generally drawing one S-shape in the plane of the MTJ element. Hereinafter, such magnetization state of the magnetization directions of the respective magnetic domains will be called S-shape.

As described above, the magnetoresistive effect element according to the present embodiment, because of the shape shown in FIG. 5A, the magnetization state given when a magnetic field is applied in the easy magnetization axis direction, and no magnetic field is applied in the hard magnetization axis direction is two C-shapes which are upward and downward symmetrical, and when a magnetic fields are applied in the easy magnetization axis direction and in the hard magnetization axis directions, the magnetization state is generally one S-shape.

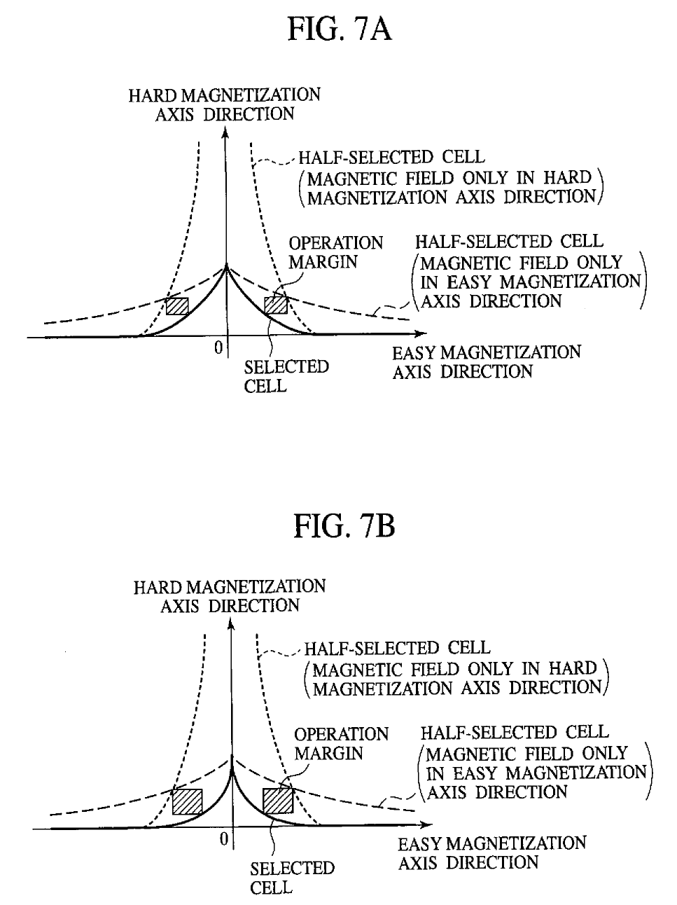

Then, before the magnetoresistive effect element according to the present embodiment is specifically explained, the asteroid curve which is an index of characteristics of the magnetoresistive effect element will be explained with reference to FIGS. 7A and 7B.

FIG. 7A is an asteroid curve of a selected cell and a half-selected cell. Here, the selected cell is a memory cell with prescribed writing magnetic fields applied to in both of the easy magnetization axis direction and the hard magnetization axis direction. The half-selected cell is a memory cell adjacent to the selected memory cell and with the same writing magnetic field as the selected cell in either of the easy magnetization axis direction and the hard magnetization axis directions applied to. To the half-selected cell with the writing magnetic field in the easy magnetization axis direction alone applied, the leakage magnetic field of the writing magnetic field in the hard magnetization axis direction applied to the selected cell is applied, and to the half-selected cell with the writing magnetic field in the hard magnetization axis direction applied, the leakage magnetic field of the writing magnetic field in the easy magnetization axis direction applied to the selected cell is applied.

The asteroid curve is a curve which shows the relationships between the applied magnetic field in the easy magnetization axis direction and the applied magnetic field in the hard magnetization axis direction necessary for the magnetization switching of the free magnetization layer of the MTJ element. That is, the region of the graph inner (nearer to the origin) of the asteroid curve is the region where a magnetization direction is not switched even with application of a magnetic fields, and the region of the graph outside the asteroid curve is a region where a magnetization direction is switched by the application of a magnetic fields.

When prescribed information is written in the MTJ element, a magnetic field necessary for the magnetization switching may be applied to the selected cell, and the magnetization directions of the half-selected cell or the non-selected cell may be retained. Accordingly, a magnetic field to be applied when the MTJ element is written must be set at the region of the selected cell, which is outer of the asteroid curve and the region of the half-selected cell, which is inner of the asteroid curve. That is, the regions hatched in FIG. 7A indicate the writing operation margin.

FIG. 7B is the asteroid curve of a selected cell having a steep profile which passes nearer the origin than the asteroid curve of FIG. 7A. In this case, as evident in the drawing, the regions of the operation margin can be larger than in FIG. 7A, and the writing margin of the MTJ element can be increased. That is, the MTJ element having the asteroid curve of a steeper profile passing nearer the origin will be generally have a larger writing operation margin.

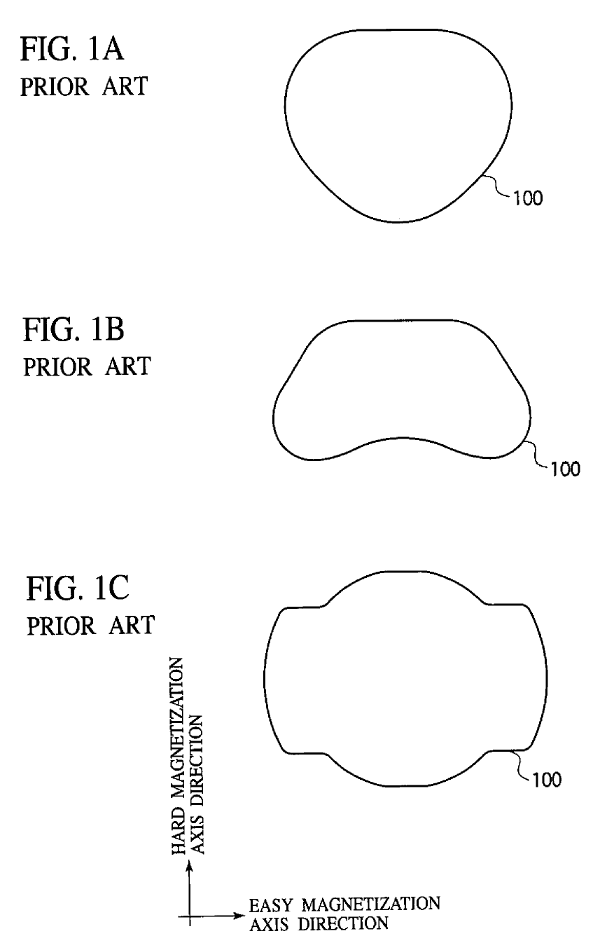

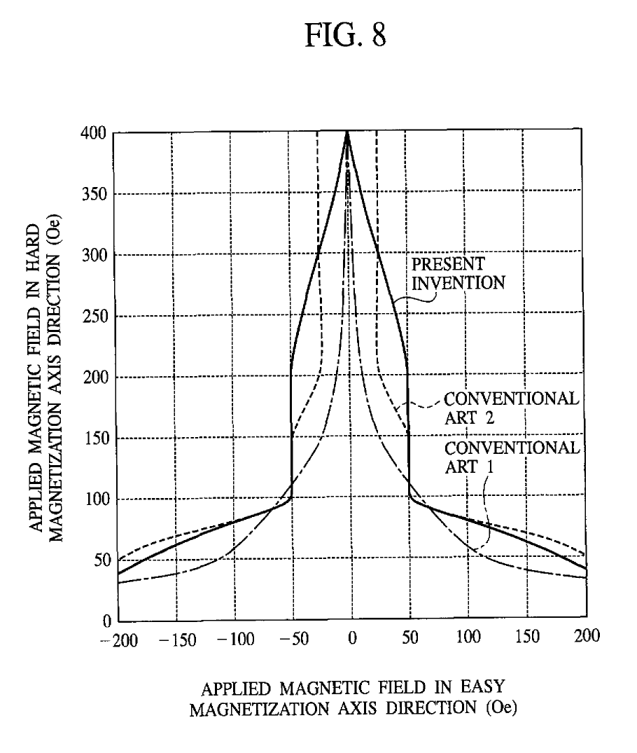

FIG. 8 is a graph of asteroid curves given by LLG simulation. In FIG. 8, the solid line indicates the asteroid curve of the MTJ element according to the present embodiment (present invention), the one-dot-chain line indicates the asteroid curve of the elliptic MTJ element (conventional art 1), and the dotted line indicates the asteroid curve of the goggles-shaped MTJ element shown in FIG. 1B (conventional art 2). In all the MTJ elements, the maximum width of the easy magnetization axis direction was 0.4 μm, and the maximum width of the hard magnetization axis direction was 0.2 μm.

As shown in FIG. 8, the asteroid curves of the MTJ element according to the present invention and the asteroid curve of the MTJ element of the conventional art 2 have steep recesses near the origin, and have profiles passing nearer the origin than the asteroid curve of the MTJ element of conventional art 1. Accordingly, the MTJ element according to the present invention and the MTJ element of conventional art 2 will have larger writing operation margins than the MTJ element of conventional art 1.

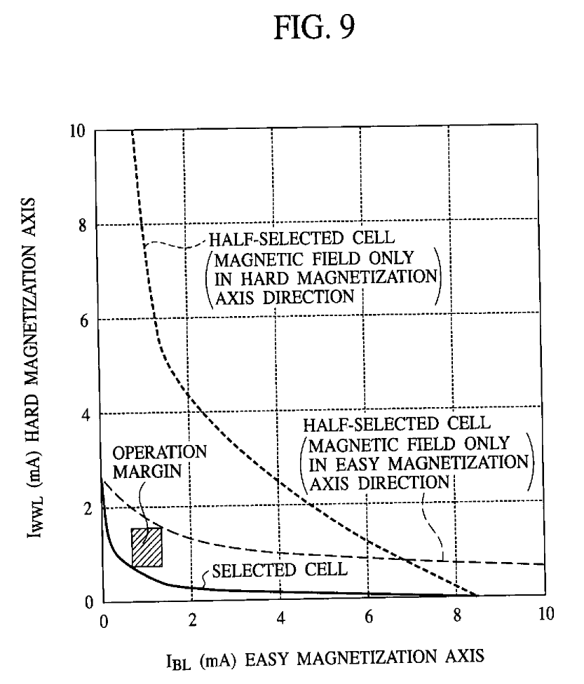

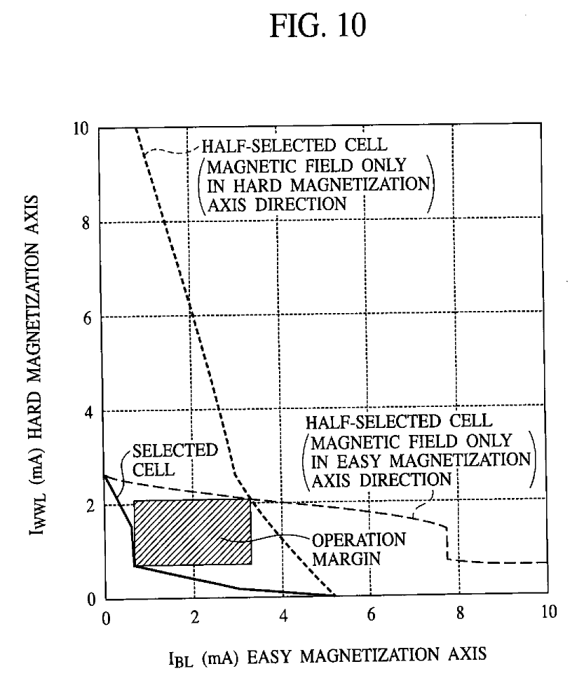

FIG. 9 shows the asteroid curves of a selected cell and a half-selected cell of the MTJ element of conventional art 1 given by LLG simulation, and FIG. 10 is the asteroid curves of the selected cell and the half-selected cell of the MTJ element according to the present embodiment given by LLG simulation. In both FIGS. 9 and 10, on the horizontal axis, the values of current flown in the signal line (bit line) for applying magnetic field in the easy magnetization axis direction are taken, the current values correspond to intensities of the magnetic field applied in the easy magnetization axis direction. On the vertical axis, the values of currents flown in the signal line (write word line) for applying magnetic field in the hard magnetization axis direction are taken, the current values correspond to the intensities of the magnetic field applied in the hard magnetization axis direction.

As shown in FIG. 10, it was confirmed that the MTJ element according to the present embodiment can much increase the writing operation margin in comparison with the MTJ element of conventional art 1 shown in FIG. 9.

In comparison of the asteroid curve of the MTJ element according to the present embodiment with the asteroid curve of the MTJ element of conventional art 2, both have substantially equal characteristics up to the applied magnetic field of about 150 Oe in the hard magnetization axis direction. However, in the asteroid curve of the MTJ element of conventional art 2, when the applied magnetic field in the hard magnetization axis direction exceed 150 Oe, the profile comes nearer to the Y axis, but in the asteroid curve of the MTJ element according to the present invention, when the applied magnetic field in the hard magnetization axis direction exceed 200 Oe, the profile comes nearer to the Y axis. This shows that the MTJ element according to the present invention is harder to be switched even when a magnetic field is excessively applied in the hard magnetization axis direction and has a larger writing operation margin than the MTJ element of conventional art 2.

The asteroid curves of the MTJ element according to the present invention and the MTJ element of conventional art 2 abruptly change at certain intensities of the applied magnetic field in the hard magnetization axis direction, because when an applied magnetic field in the hard magnetization axis direction exceed prescribed values, the magnetization states of the magnetic domains in the plane of the MTJ elements change from the C-shape to the S-shape.

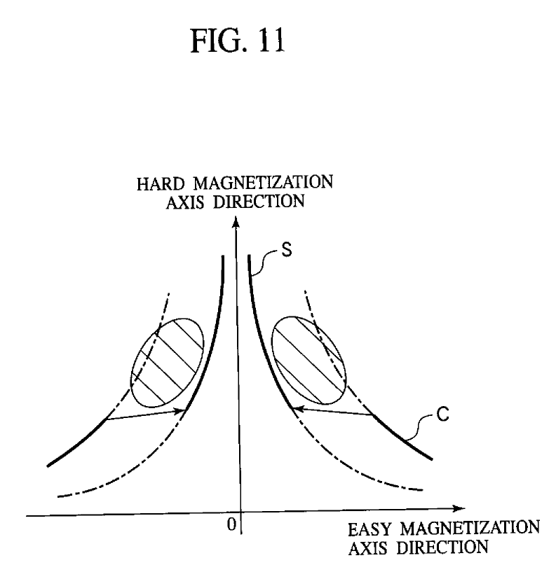

As shown in FIG. 11, the asteroid curve of the MTJ element having the C-shaped magnetization state positions outer of the asteroid curve of the MTJ element having the S-shaped magnetization state. The magnetization changes from the C-shape to the S-shape to approach the asteroid curve to the Y axis in the region where the hard axis magnetic field is large. Such abrupt change of the profile improves the writing operation margin in the regions indicated by the ellipses.

The MTJ element according to the present invention is equal to the MTJ elements of the prior art in the writing current operation condition and is not high, and the electric power consumption can be decreased in comparison with that in the writing by the toggle operation.

Two C-shaped magnetization states being formed in the plane of the MTJ elements is a characteristic of the MTJ element of the magnetic memory device according to the present embodiment. This characteristic will be a factor for increasing the writing operation margin than the MTJ element of conventional art 2. The mechanism for increasing the writing operation margin is not clear but will be as exemplified below.

That is, two C-shaped magnetization states being formed in the MTJ element according to the present embodiment corresponds to a couple of two MTJ elements having the C-shape and a half size. A smaller MTJ element has a larger switching magnetic field. Based on this, the inventor of the present application considers that the MTJ element of the magnetic memory device according to the present embodiment has a small effective size, and the switching magnetic field intensity increases.

The plane shape of the MTJ element of the magnetic memory device according to the present embodiment shown in FIG. 5A simply has a rectangular shape having horizontally symmetric recesses in the shorter sides, which facilitate the design. The left and the right recesses are the same in the shape, size, position and number, which makes the asteroid curve symmetric to the hard magnetization axis, and the margin for the MRAM operation can be increased. The recesses 68 have a shape tapered toward the inside, whereby the C-shaped magnetization can be stably formed in the state with the easy magnetization axis magnetic field applied.

Generally, for the shape of the MTJ element, it is preferable to set the aspect ratio in consideration of stabilizing the magnetization of the free magnetization layer so that the length in the easy magnetization axis direction is longer. However, in the MTJ element according to the present invention, even with the aspect ratio set at 1:1, the C-shaped magnetization states corresponding to the shape given with an aspect ratio set approximate to 1:2 are formed in upper and below the recesses, and resultantly an asteroid curve which can ensure a sufficiently operation margin can be given. This means that the MTJ element can be downsized to a half area in comparison with the MTJ element having the aspect ratio set at, e.g., 1:2 very effectively also for the high integration.

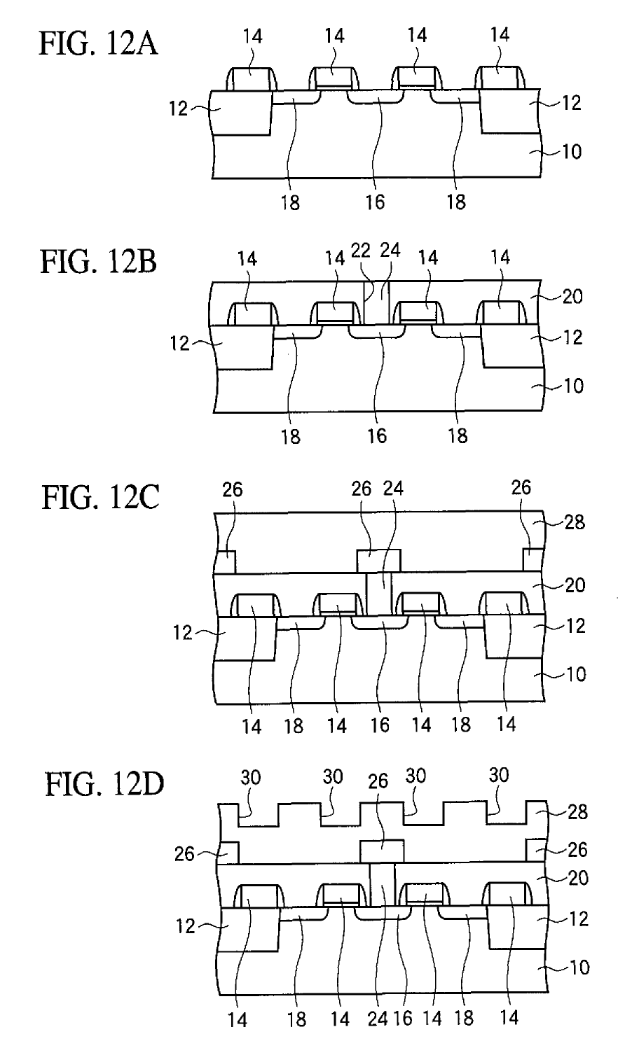

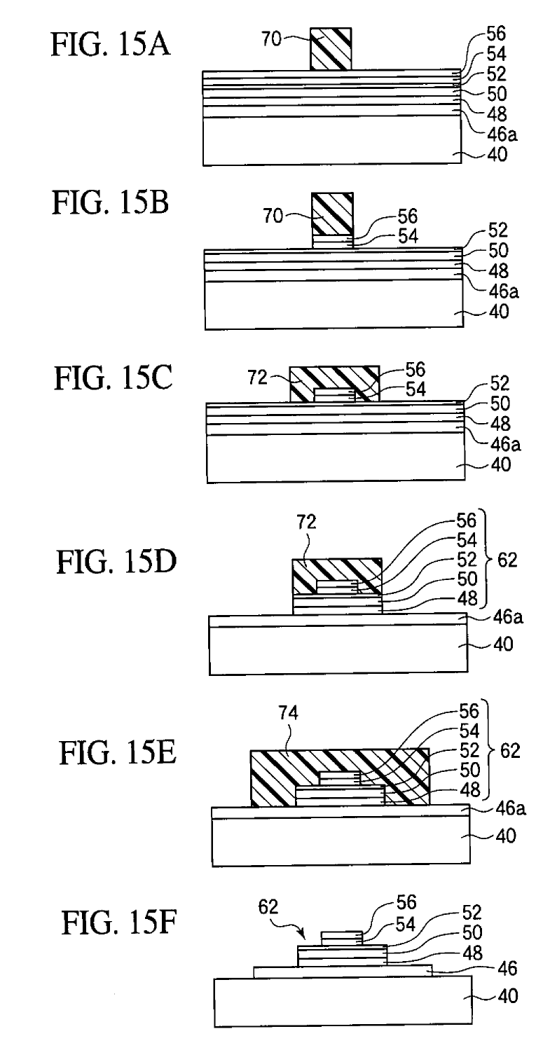

Next, the method of manufacturing the magnetic memory device according to the present embodiment will be explained with reference to FIGS. 12A to 15F. FIGS. 12A to 14C are sectional views of the whole memory cell including the select transistor and the MTJ element in the steps of the method of manufacturing the magnetic memory device, and FIGS. 15A-15F are partially enlarged sectional views of the MTJ element in the steps of the method of manufacturing the MTJ element.

First, the device isolation film 12 is formed in the silicon substrate 10 by, e.g., STI (Shallow Trench Isolation) method.

Next, on the active regions defined by the device isolation film 12, select transistors each including the gate electrode 14 and the source/drain regions 16, 18 are formed in the same way as in the usual MOS transistor manufacturing method (FIG. 12A).

Next, over the silicon substrate 10 with the select transistors formed on, a silicon oxide film is deposited by, e.g., CVD method, and then the surface of the silicon oxide film is planarized by CMP method to form the inter-layer insulating film 20 of the silicon oxide film.

Then, by lithography and dry etching, the contact hole 22 is formed in the inter-layer insulating film 20 down to the source/drain region 16.

Next, by, e.g., CVD method, a titanium nitride film as a barrier film and a tungsten film are deposited, and these conductive films are etched back or polished back to form the contact plug 24 buried in the contact hole 22 and electrically connected to the source/drain region 16 (FIG. 12B).

Then, over the inter-layer insulating film 20 with the contact plug 24 buried in, a conductive film is deposited and patterned to form the ground line 26 electrically connected to the source/drain region 16 via the contact plug 24.

Then, over the inter-layer insulating film 20 with the ground line 26 formed on, a silicon oxide film is deposited by, e.g., CVD method, and the surface of the silicon oxide film is planarized by CMP method to form the inter-layer insulating film 28 of the silicon oxide film (FIG. 12C).

Then, by photolithography and dry etching, the interconnection trenches 30 for burying the write word lines in are formed in the inter-layer insulating film 28 (FIG. 12D).

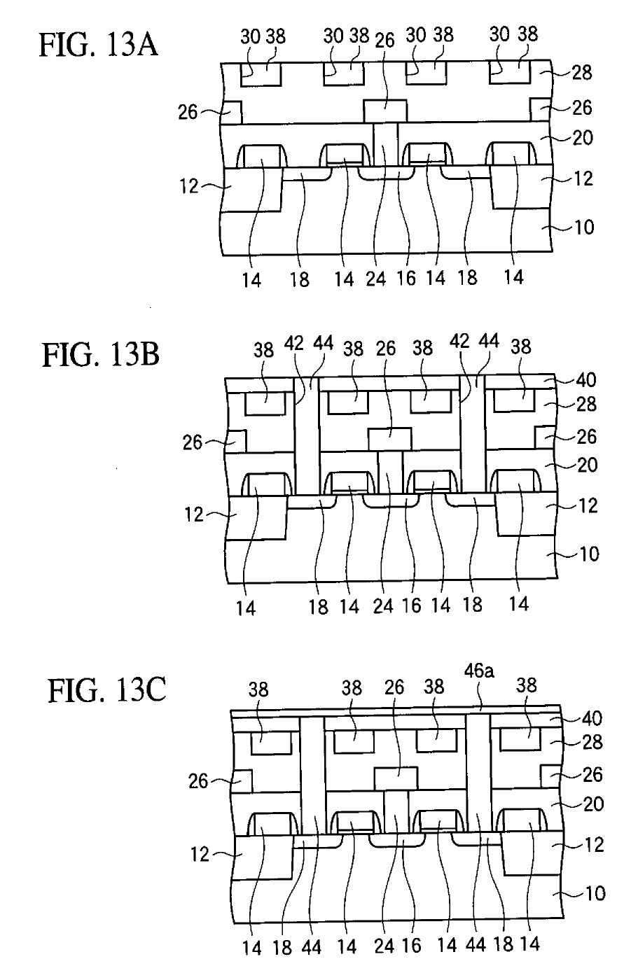

Next, the Ta film 32 and the NiFe film 34, and the Cu film 36 are deposited respectively by, e.g., sputtering method and by, e.g., electroplating method, and these conductive films are planarized by CMP method to form the write word lines 38 buried in the interconnection trenches 30 (FIGS. 4 and 13A).

Next, over the inter-layer insulating film 28 with the write word lines 38 buried in, a 100 nm-thickness silicon oxide film, for example, is deposited by, e.g., CVD method, and the surface of the silicon oxide film is planarized by CMP method to form the inter-layer insulating film 40 of the silicon oxide film.

Then, by photolithography and dry etching, the contact holes 42 are formed in the inter-layer insulating films 40, 28, 20 down to the source/drain regions 18.

Next, by, e.g., CVD method, a titanium nitride film as a barrier metal and a tungsten film are deposited, and these conductive films are etched back or polished back to form the contact plugs 44 buried in the contact holes 42 and electrically connected to the source/drain region 18 (FIG. 13B).

Then, by, e.g., sputtering method, a 40 nm-thickness Ta film 46a, for example, is deposited (FIG. 13C).

Next, on the Ta film 46a, the antiferromagnetic layer 48 of, e.g., a 15 nm-thickness PtMn, the pinned magnetization layer 50 of, e.g., a 2 nm-thickness CoFe film 50a, e.g., a 0.9 nm-thickness Ru film 60b and, e.g., a 3 nm-thickness CoFe film 50c, the tunnel insulating film 52 of, e.g., a 1.2 nm-thickness alumina, and the free magnetization layer 54 of, e.g., a 6 nm-thickness NiFe, and the cap layer 56 of, e.g., a 30 nm-thickness Ta film are sequentially formed by, e.g., sputtering method.

Then, a photoresist film 70 having the pattern of the free magnetization layer to be formed is formed by photolithography. The photoresist film 70 has a rectangular shape shown in FIG. 5A, which is longer, e.g., in the direction of extension of the word lines WL (e.g., in the X direction in FIG. 2) and has the recesses in the shorter sides (FIG. 15A).

The shape of the MTJ element 62 shown in FIG. 5A, which can be drawn in accordance with length, width and diagonal patterning rules can be designed by the process according to the conventional silicon technology and can be easily realized.

Then, with the photoresist film 70 as the mask, dry etching is made to pattern the free magnetization layer 54 and the cap layer 56. Thus, the free magnetization layer 54 e.g., having the 200×300 nm rectangular shape which is longer in the direction of extension of the word lines WL (e.g., in the X direction in FIG. 2) and having the recesses in the shorter sides is formed (FIG. 15B).

Then, the photoresist film 70 is removed, and then by photolithography, a photoresist film 72 having the pattern of the pinned magnetization layer to be formed is formed. The photoresist film 72 has a rectangular shape which is a little larger than the pattern of the free magnetization layer 54 (FIG. 15C).

Next, with the photoresist film 72 as the mask, dry etching is made to pattern the tunnel insulating film 52, the pinned magnetization layer 50 and the antiferromagnetic layer 48. Thus, the MTJ element 62 including the layer structure of the antiferromagnetic layer 48, the pinned magnetization layer 50, the tunnel insulating film 52, the free magnetization layer 54 and the cap layer 56 and having a rectangular pattern with the recesses formed in the shorter sides of the free magnetization layer 54 (FIG. 15D).

According to the method for manufacturing the magnetoresistive memory according to the present embodiment, the free magnetization layer 54 and the pinned magnetization layer 50 are separately patterned, whereby the electric short between the free magnetization layer 54 and the pinned magnetization layer 50 with side wall adhesives generated in the patterning can be suppressed. Thus, the production yield can be high.

Then, the photoresist film 72 is removed and then a photoresist film 74 having the pattern of the lower electrode layer 46 to be formed is formed by photolithography (FIG. 15E).

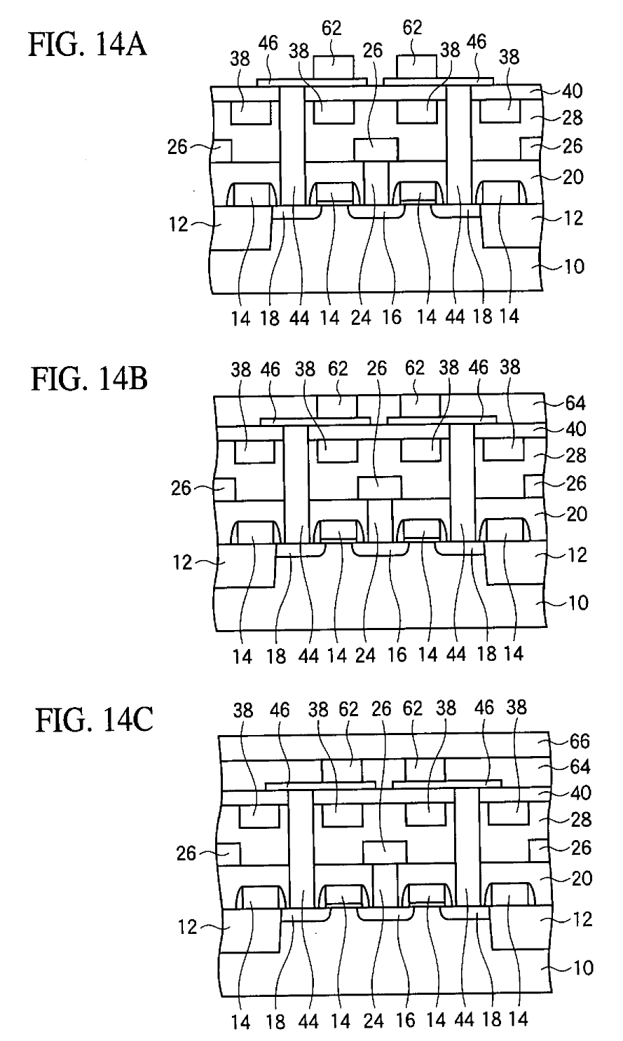

Next, dry etching is made with the photoresist film 74 as the mask to pattern the Ta film 46a. Thus, the lower electrode layer 46 formed of the Ta film 46a and electrically connecting the MTJ element 62 to the source/drain region 18 via the contact plug 44 is formed (FIGS. 15F and 14A).

Next, over the inter-layer insulating film 40 with the MTJ elements 62 formed on, a silicon oxide film is deposited by, e.g., CVD method and then is planarized by CMP method until the MTJ elements 62 are exposed to form the inter-layer insulating film 64 of the silicon oxide film having the surface planarized (FIG. 14B).

Next, over the inter-layer insulating film 64 with the MTJ elements 62 buried in a conductive film is deposited and patterned to form the bit lines 66 connected to the MTJ elements 62 (FIG. 14C).

Hereafter, insulating layers, interconnection layers, etc. are further formed as required, and the magnetic memory device is completed.

As described above, according to the present embodiment, the free magnetization layer has a plane shape having recesses in a pair of sides which are in parallel with the hard magnetization axis direction, whereby because of increase of an applied magnetic field in the hard magnetization axis direction, the characteristic that the magnetization state in which two regions where the magnetization directions of the magnetic domains draw C-shapes are formed adjacent to each other in the hard magnetization axis direction changes to the magnetization state in which the magnetization directions of the magnetic domains are arranged, generally drawing one S-shape can be presented. This can increase the switching magnetic field intensity when a magnetic field in the hard magnetization axis direction is weak, whereby the disturbance resistance can be increased while the switching magnetic field intensity is lowered when a magnetic field in the hard magnetization axis direction is intense, whereby the writing operation can be easy. In comparison with the conventional magnetoresistive effect element, the decrease ratio of the switching magnetic field intensity in the easy magnetization axis direction due to increase of a magnetic field in the hard magnetization axis direction can be decreased. This can increase the writing operation margin.

The applied magnetic field intensity necessary to writing in the magnetoresistive effect element including the free magnetization layer having the above-described plane shape is substantially equal to that necessary to writing in the conventional magnetoresistive effect element and can decrease the electric power consumption in comparison with the writing by the toggle operation.

The above-described shape of the free magnetization layer can be realized in the range where the silicon process is applicable. This makes it possible to realize the magnetoresistive effect element of high performance without adding new processing techniques.

The present invention is not limited to the above-described embodiment and can cover other various modifications.

For example, in the above-described embodiment, the MTJ element 62 is formed in the plane shape shown in FIG. 5A, but the shape which can produce the effect of the present invention is not limited to the shape shown in FIG. 5A.

The magnetoresistive effect element according to the present invention is characterized mainly in that with a magnetic field applied in the easy magnetization axis direction alone, two C-shaped magnetization states are formed in the element plane, and the shape of FIG. 5A may be variously modified as long as the various modifications can produce the effect of the present invention.

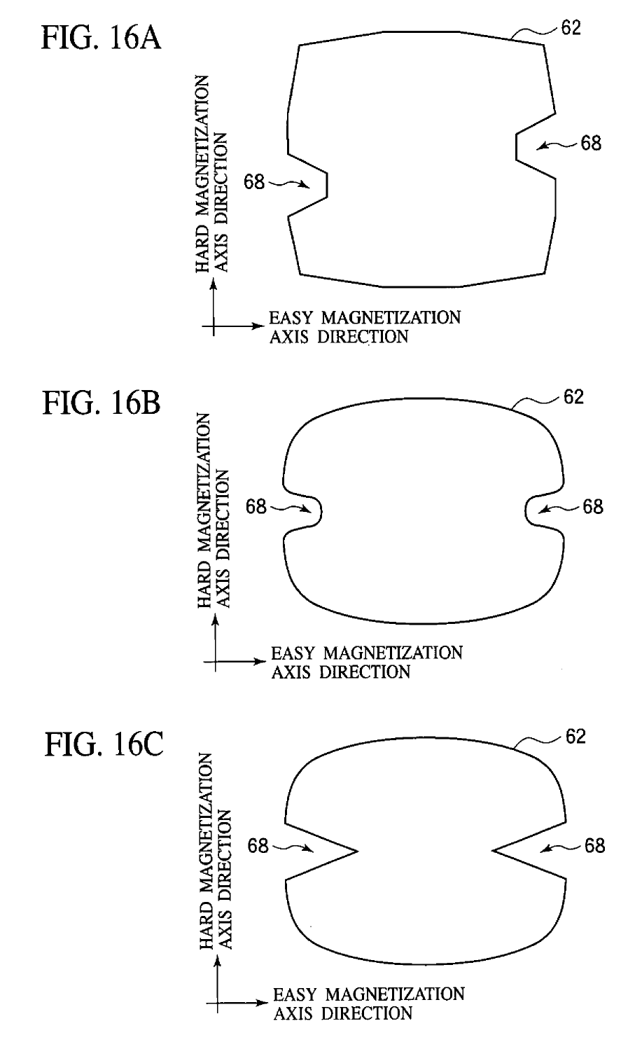

The basic shape of the MTJ element 62 may not be rectangular. For example, as shown in FIG. 16A, the MTJ element 62 may have a convex polygon. The recesses 68 may be positioned left and right at different heights.

Otherwise, as shown in FIG. 16B, the MTJ element 62 may have the corners rounded. In the lithography for, e.g., the downsized processing of more than 0.4 μm, the design shape shown in FIG. 5A presents the actually formed shape shown in FIG. 16B due to the optical proximity effect.

Otherwise, as shown in FIG. 16C, the MTJ element 62 may have the shape having the contour except the recesses 68 rounded. The recesses 68 having the width decreased toward the inside of the MTJ element 62 produces the effect that, as described above, the C-shaped magnetization state can be formed stably with an easy magnetization axis magnetic field alone is applied.

The shapes having the recesses 68 at the symmetrical positions lengthwise as shown in FIGS. 16B and 16C, the synthetic magnetic field intensity for transforming the C-shape to the S-shape in the upper half and the synthetic magnetic field for transforming the C-shape to the S-shape in the lower half are equal to each other, whereby the fluctuations of the asteroid curve can be suppressed.

In the above-described embodiment, the MTJ element is patterned in the shape shown in FIG. 5A only on the side of the free magnetization layer but may be patterned in the shape shown in FIG. 5A both in the free magnetization layer and the pinned magnetization layer.

In the above-described embodiment, the pinned magnetization layer 50 has the synthetic ferrimagnetic structure of the CoFe film 50a, the Ru film 50b and the CoFe film 50c so as to decrease the leakage magnetic field form the pinned magnetization layer 50, but, for example, a pinned magnetization layer of the single layer structure of CoFe.

In the above-described embodiment, the free magnetization layer 54 has the single layer structure of NiFe but may have the layer structure of CoFe/Ru/CoFe, as has the pinned magnetization layer 50.

In the above-described embodiment, the write word lines 38 are extended in the easy magnetization axis direction of the MTJ element 62, and the bit lines 66 are extended in the hard magnetization axis direction of the MTJ element. However, the bit lines 66 may be extended in the easy magnetization axis direction of the MTJ element 62, and the write word lines 38 may be extended in the hard magnetization axis direction of the MTJ element. The signal lines to be used in writing in the MTJ elements are not essentially the write word lines 38 and the bit lines 66 and may be suitably selected in accordance with a layout and a structure of the memory cells.

In the above-described embodiment, the present invention is applied to the magnetic memory device of 1T-1MTJ type including one select transistor and one MTJ element form one memory cell, but the structure of the memory cell is not essentially to this. For example, the present invention is applicable to the magnetic memory device of 2T-2MTJ type and the magnetic memory device of 1T-2MTJ type, etc.

In the above-described embodiment, the magnetoresistive effect element is the MTJ element. However, the present invention is applicable widely to magnetoresistive effect elements utilizing the resistance change due to relationships of spins between magnetic layers. For example, the present invention is applicable to the magnetoresistive effect element including two magnetic layers stacked with a non-magnetic layer formed therebetween.

In the above-described embodiment, the magnetoresistive effect element according to the present invention is applied to the magnetic memory device but may be applied to other devices using the magnetoresistive effect element.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A magnetoresistive effect element comprising:
a first magnetic layer having a pinned magnetization direction,
a second magnetic layer having a magnetization direction changed corresponding to an outside magnetic field,
wherein a resistance state is changed corresponding to the magnetization direction of the second magnetic layer corresponding to the magnetization direction of the first magnetic layer,
wherein the second magnetic layer has a first recess which is dented toward an inside in one side parallel with a hard magnetization axis direction and a second recess dented toward the inside in the other side parallel with the hard magnetization axis direction.

2. The magnetoresistive effect element according to claim 1, wherein
the second magnetization layer has a rectangular shape having said first recess formed in said one side and the second recess formed in said the other side.

3. The magnetoresistive effect element according to claim 1, wherein
the first recess and the second recess are formed symmetric to a center line of the second magnetic layer in an easy magnetization axis direction.

4. The magnetoresistive effect element according to claim 1, wherein
the first recess and the second recess are formed symmetric to a center line of the second magnetic layer in the hard magnetization axis direction.

5. The magnetoresistive effect element according to claim 1, wherein
the first recess and the second recess have a width decreased toward the inside of the second magnetic layer.

6. The magnetoresistive effect element according to claim 1, wherein
the second magnetic layer has corners of the contour rounded.

7. The magnetoresistive effect element according to claim 1, wherein
a width of the second magnetization layer in an easy magnetization axis direction is larger than a length of the second magnetic layer in the hard magnetization axis direction.

8. The magnetoresistive effect element according to claim 1, wherein
when a magnetic field is applied in an easy magnetization axis direction, and no magnetic field is applied in the hard magnetization axis direction, two C-shaped magnetized states of magnetization directions of the respective magnetic domains, which are oriented in the easy magnetization axis direction, drawing arcs with the summits at center of the second magnetic layer are formed respectively in two regions defined by a border interconnecting the first recess and the second recess, and
when magnetic fields are applied in the easy magnetization axis direction and in the hard magnetization axis direction, a one generally S-shaped magnetized state of magnetization directions of the respective magnetic domains, which are oriented toward a synthetic magnetic field of the applied magnetic field in the easy magnetization axis direction and the applied magnetic field in the hard magnetization axis direction.

9. The magnetoresistive effect element according to claim 1, wherein
the first magnetic layer has a plane shape different from a plane shape of the second magnetic layer.

10. The magnetoresistive effect element according to claim 1, wherein
the first magnetic layer has a same plane shape as the second magnetic layer.

11. A magnetic memory device comprising:
a first interconnection;
a second interconnection intersecting the first interconnection; and
a magnetoresistive effect element disposed in an intersection region between the first interconnection and the second interconnection,
wherein the magnetoresistive effect element includes
a first magnetic layer having a pinned magnetization direction,
a second magnetic layer having a magnetization direction changed corresponding to an outside magnetic field,
wherein a resistance state is changed corresponding to the magnetization direction of the second magnetic layer corresponding to the magnetization direction of the first magnetic layer,
wherein the second magnetic layer has a first recess which is dented toward an inside in one side parallel with a hard magnetization axis direction and a second recess dented toward the inside in the other side parallel with the hard magnetization axis direction.

12. The magnetic memory device according to claim 11, wherein
the first interconnection is formed, extended in an easy magnetization axis direction of the second magnetic layer of the magnetoresistive effect element, and
the second interconnection is formed, extended in the hard magnetization axis direction of the second magnetic layer of the magnetoresistive effect element.

13. The magnetic memory device according to claim 11, wherein
the second magnetization layer has a rectangular shape having said first recess formed in said one side and the second recess formed in said the other side.

14. The magnetic memory device according to claim 11, wherein
the first recess and the second recess are formed symmetric to a center line of the second magnetic layer in an easy magnetization axis direction.

15. The magnetic memory device according to claim 11, wherein
the first recess and the second recess are formed symmetric to a center line of the second magnetic layer in the hard magnetization axis direction.

16. The magnetic memory device according to claim 11, wherein
the first recess and the second recess have a width decreased toward the inside of the second magnetic layer.

17. The magnetic memory device according to claim 11, wherein
the second magnetic layer has corners of the contour rounded.

18. The magnetic memory device according to claim 11, wherein
a width of the second magnetization layer in an easy magnetization axis direction is larger than a length of the second magnetic layer in the hard magnetization axis direction.

19. The magnetic memory device according to claim 11, wherein
when a magnetic field is applied in an easy magnetization axis direction, and no magnetic field is applied in the hard magnetization axis direction, two C-shaped magnetized states of magnetization directions of the respective magnetic domains, which are oriented in the easy magnetization axis direction, drawing arcs with the summits at center of the second magnetic layer are formed respectively in two regions defined by a border interconnecting the first recess and the second recess, and
when magnetic fields are applied in the easy magnetization axis direction and in the hard magnetization axis direction, a one generally S-shaped magnetized state of magnetization directions of the respective magnetic domains, which are oriented toward a synthetic magnetic field of the applied magnetic field in the easy magnetization axis direction and the applied magnetic field in the hard magnetization axis direction.
